(19) United States
(12) Patent Application Publication
(10) Pub. No.: US 2006/0075450 A1
(43) Pub. Date: Apr. 6, 2006

(54) Systems, devices, and methods for providing high-resolution, live, real-time video signal data and other data using low frequency bandwidth

(76) Inventors: David Haas, Allentown, PA (US); Richard Kucsan, Mertztown, PA (US); Thomas C. Ball, Allentown, PA (US); Douglas R. Greaser, Bethlehem, PA (US)

Correspondence Address: EDWARDS & ANGELL, LLP, P.O. BOX 55874, BOSTON, MA, 02205, US

(21) Appl. No.: 10/960,417

(22) Filed: Oct. 6, 2004

(51) Int. Cl. H04N 7/173

(52) U.S. Cl. 725/121

(57) ABSTRACT

Devices, systems, and methods for providing data, especially video signal data, to a remote location using low frequency bandwidths is disclosed. Transmission of low frequency bandwidths from a transmitting unit to a receiving unit located up to about 15 miles line-of-sight is possible. Adding one or more bridge antennas between the transmitting and receiving units can increase the transmission distance to hundreds of miles line-of-sight. At the receiving unit, data is retransmitted to a facility network for display and/or storage. Control of data generating devices can also be controlled remotely from the remote location or to Internet uses wherever they may be.

### BACKGROUND OF THE INVENTION

1. Field of the Invention

The present invention relates to surveillance and monitoring devices, systems, and methods for providing communication data from a remote location and, more specifically, to devices, systems, and methods for providing data, especially live, real-time, low frequency, high resolution video signal data, from a remote location, and, further, for controlling data generating devices, especially video recording devices, from a remote location.

2. Background Art

Surveillance, monitoring, and security systems are well known in the art.

For example, facilities such as banks, airports, bus stations, train stations, subway stations, shipping docks, office buildings, government buildings, military installations, correctional facilities, parking lots, shopping malls, and the like require increasingly higher levels of security, which, in turn, require increasingly higher levels of surveillance and monitoring. Typically, such surveillance includes additional security guards and/or more remote electronic surveillance, e.g., using live video feed cameras.

Generally, for most terrestrial applications, video surveillance systems use a plurality of strategically-placed surveillance cameras that provide data, e.g., analog signals, to one or more remote, monitoring facilities. Each monitoring facility, typically, is equipped with one or more video consoles that provide real time surveillance and/or video recording equipment. The captured video feed can be reviewed at a later time with greater scrutiny, if events warrant such review. When only a single console is used in conjunction with multiple surveillance cameras, each camera is displayed on the display device of the console intermittently or, alternatively, the video feed from each camera is displayed on a multi-image split screen.

Conventional surveillance and monitoring systems include closed-circuit, hardwired systems. For example, twisted pair cable, which, traditionally, is used for wiring telephones and local area networks (“LAN”), is widely used because of ease of installation and relative expense. Improved twisted pair cable, e.g., Category 5 cable, can provide higher bandwidth and is especially suitable for closed-circuit applications. Coaxial cables are also prevalent in conventional closed-circuit systems. Although well suited for the application fiber-optic cables are not widely used because of their high cost.

As an alternative to hardwired systems, wireless systems have also been proposed for use with surveillance and monitoring systems. Wireless systems use non-secure radio frequency (“RF”) energy to transmit data. Typically, a wireless RF system includes a low power, ultra-high frequency (“UHF”) transmitter system that transmits a signal that is receivable by conventional television monitors and/or dedicated tele-receivers, which are tuned to the transmitting UHF channel. Because of the power transmission levels typically associated with their use, use of UHF does not require a license from the Federal Communications Commission (“FCC”). Advantageously, wireless RF systems are easier to install than hardwired systems. However, disadvantages of traditional wireless systems include their susceptibility to noise and other interference, lack of security, and, due to their low power application, their limited range.

Digital, Internet “web cams” have proliferated recently as yet another video signal data communication means. However, state-of-the-art “web cams” are designed primarily for direct point-to-point communication with or between personal computers (“PC”). As a result, their suitability for surveillance and monitoring is hampered by poor resolution and, further limited by slow refresh rates that can produce a jerky image. As a result, for surveillance and monitoring systems, “web cams” offer an incomplete, unacceptable solution.

Finally, the technologies associated with video teleconferencing offer yet another means of providing surveillance and monitoring. Typically, video teleconferencing can use common telecommunication circuits and/or the Internet. For the longest distances for distribution of video, the video signals are digitally compressed for transmission and decompressed at the receiving end. The former typically is limited in the amount of data that can be collected and/or transmitted. Internet teleconferencing also is capable of transmitting live, real-time video data. However, Internet teleconferencing typically requires a modem and video compression, which lowers the transmission rate with a corresponding lower image quality. Thus, many of these PC-based systems do not have the resolution or the refresh rate necessary for a good surveillance and monitoring system.

Extraterrestrial application of surveillance and monitoring systems includes the air transportation industry and satellites. For years the air transportation industry has included audio and video recorders aboard aircraft to record flight data and, moreover, to provide critical information that can be used to assess the cause(s) of an aircraft catastrophe. For example, voice recorders in the cockpit of the aircraft and flight data recorders collect audio and radio communications, which are stored in a “black box” that can be recovered and used after-the-fact to understand the cause(s) of a catastrophic event.

Others have proposed systems to provide live video feeds from inside an aircraft, e.g., the cockpit, cargo hold, main cabin, and the like. However, air-to-ground transmission of a video feed from an airborne aircraft traditionally has been limited to relatively short distances. Furthermore, air-to-ground transmissions are line-of-sight (“LOS”) transmissions that use standard video broadcast format, e.g., NTSC, PAL, SECAM, and the like.

One exemplary system found in Patent Application Publication No. 2004/0008253 to Monroe (“Monroe”) discloses a monitoring system that combines live, real-time, transmission of data of events occurring onboard an aircraft to remote locations, e.g., vehicles, command centers, radio towers, other aircraft, emergency rescue vehicles, security and/or rescue personnel, and the like, with immediate recording of audio and visual information to provide a historical record for review.

Monroe is primarily directed to airborne transportation. Indeed, Monroe teaches that, the aircraft are equipped with a plurality of cameras and other sensors that are disposed strategically about the aircraft. The cameras and other sensors can provide continuous monitoring and/or can be activated automatically upon the occurrence of movement or some other detectable event. The cameras and sensors generate data that can be collected and retransmitted to monitoring equipment onboard the aircraft, e.g., to a display console in the cockpit, as well as to one or more remote monitoring stations.

Monroe purports to provide a system that monitors aircraft in flight, aircraft in an airport or other vehicles en route, collecting and transmitting, inter alia, data relating to onboard conditions. According to Monroe, the system supplies data to local and remote monitoring stations by way of redundant communication networks, e.g., wired and wireless links. More particularly, Monroe teaches access of the information by permanent monitoring stations as well as mobile units and/or personnel having access to a wireless data transceiver, e.g., a portable computer, a personal digital assistant (“PDA”), and the like.

Typically, the remote monitoring station disclosed by Monroe can be stationary or moving, temporary or permanent and, further, can include wireless transmission equipment for receiving data from and transmitting data to the aircraft, response vehicles, emergency personnel, and various ground based remote stations. Moreover, personnel in the response centers, emergency rescue vehicles or with portable equipment can select and control onboard sensors, which enables emergency response personnel to control the orientation of the onboard cameras and sensors remotely.

However, Monroe relies on widespread high frequency, very high frequency (“VHF”), and UHF communication channels, which, although highly reliable, typically, require a medium to high, dedicated bandwidth. The bandwidth requirement, further, requires FCC licensing and would become unmanageable and expensive if more and more aircraft were wired as taught by Monroe to provide data.

Therefore, it is desirable to provide an economical, low frequency, line-of-sight, wireless surveillance and monitoring system that can provide live, real-time, streaming video feeds to remote locations without having to dedicate a significant bandwidth to the system.

### SUMMARY OF THE INVENTION

The present invention provides devices, systems, and methods for collecting, processing, and transmitting data to one or more remote locations using low frequency bandwidth. The devices, systems, and methods of the present invention can be used to provide video data, audio data, and text data to remote locations using low frequency bandwidth.

In one preferred embodiment, the system comprises one or more transmitting units, each comprising a transceiver for collecting, processing, and transmitting data received from one or more data generating devices, and one or more remote receiving devices that receive, process, and re-transmit the transmitted data to a facility network. In further embodiments, the system comprises at least one antenna that is in communication with the transmitting unit(s) and at least one antenna that is in communication with the receiving device(s). Moreover, in another embodiment, the transmitting units comprise data generating devices tat provide data to the transceiver.

According to this preferred embodiment, the transceiver transmits data using a low frequency bandwidth. Preferably, the low frequency bandwidth is between about 2.4 Giga-hertz and about 1 Terra-hertz ISM and more preferably, the low frequency bandwidth is between about 2.4 Giga-hertz and about 5.8 Giga-hertz ISM.

In another preferred embodiment, the system comprises one or more video units, wherein each of the one or more video units comprises a transceiver for collecting, processing, and transmitting the video signal data and one or more remote receiving devices that receive, process, and re-transmit the transmitted video signal data to a facility network. In further embodiments, the system comprises at least one antenna that is in communication with the video unit(s) and at least one antenna that is in communication with the receiving device(s). Moreover, in another embodiment, the video units comprise video recording devices or other data generating devices that, respectively, provide video data or other data to the transceiver.

According to this preferred embodiment, the transceiver transmits data using a low frequency bandwidth. Preferably, the low frequency bandwidth is between about 2.4 Giga-hertz and about 1 Terra-hertz ISM and more preferably, the low frequency bandwidth is between about 2.4 Giga-hertz and about 5.8 Giga-hertz ISM.

In another embodiment, each video unit is a mobile video unit that further includes a mobile video carrier to transport the video recording device(s) to a particular location. Video recording devices useful in the practice of the present invention include a video camera having at least a 16× zoom feature, at least a 340-degree pan feature, and at least a 100-degree tilt feature. Digital video cameras wherein the zoom-, pan- and tilt features are controllable locally or remotely using a controller are particularly suitable.

In another aspect of the present invention, the one or more video recording devices can also include one or more closed-circuit cameras, night vision devices and/or infra-red cameras that provide video signal data to the transceiver through an NTSC connection.

In yet another aspect of the present invention, the one or more video recording device are operated continuously or are structured and arranged with a motion sensor that actives the video recording device upon detection of any movement. For some applications of the present invention, the one or more video recording devices ares structured and arranged to provide video signal data at a rate of between about 15 frames per second and about 30 frames per second.

In still another embodiment of the present invention, the system also includes a controller to control the positioning and orientation of the video devices and to enable communication of video signal data to the remote receiving devices.

Preferably, the transceiver encodes and compresses the video signal data received video recording devices. More preferably, encoding includes a 128-bit encryption scheme or a wireless-fidelity, WEP security layer. More preferably, the remote receiving devices decode the signal data received using the same.

In a further embodiment of the present invention, the antenna is an omni-directional antenna or a focused, directional antenna, which is capable of transmitting data and receiving signals at a range of about 15 miles (line-of-sight). Moreover, if the distance between the antenna and a remote receiving device(s) exceeds about 15 miles or if there is not 15 miles line-of-sight, then the system further comprises one of more bridge antennas, wherein each of the one or more bridge antennas has a line-of-sight communication with the remote receiving device(s) or another bridge antenna. Accordingly, low frequency transmissions can be transmitted to distances of (n+1) times 15 miles (line-of-sight), where n is the number of bridge antennas.

In another embodiment of the present invention, each remote receiving device comprises a main antenna, a base unit, and a facility network connection. Preferably, the facility network connection provides an access or a gateway to the Internet, an intranet, a wide area network, and a local area network, a public switched telephone network, a cellular communication network, a digital pager, and/or a wireless communication network.

In yet another embodiment of the present invention, the system further comprises a system controller that is structured and arranged to enable authorized users to access the system and to provide the capability to control the positioning and orientation of the video devices from remote locations.

In a further embodiment, the present invention also provides methods for collecting, processing, and transmitting data to one or more remote locations using low frequency transmissions. More specifically, the embodied method comprising the steps of:

providing a network having one or more transmitting units, and one or more receiving units, wherein each of the one or more transmitting units receives data from one or more data generating devices;

processing the data received from the one or more data generating devices;

transmitting the processed data to the one or more receiving units;

processing the transmitted data;

transmitting the processed data to a facility network; and

displaying the data on a display device in communication with the facility network to one or more authorized users.

In yet another embodiment of the present invention also provides methods for collecting, processing, and transmitting data to one or more remote locations using low frequency transmissions. More specifically, the embodied method comprising the steps of:

providing a network having one or more transmitting units, and one or more receiving units, wherein each of the one or more transmitting units receives data from one or more video recording devices;

processing the data received from the one or more video recording devices;

transmitting the processed data to the one or more receiving units;

processing the transmitted data;

transmitting the processed data to a facility network; and

displaying the video signal data on a display device in communication with the facility network to one or more authorized users.

Preferably, the steps of receiving, processing, and re-transmitting the video signal data includes providing a line-of-sight transmission between the transceiver and the base unit, wherein a distance between the transceiver and the base unit does not exceed about 15 miles unless there are additional bridge antennas. More preferably if there is no line-of-sight between the transceiver and the base unit or the distance between the transceiver and the base unit exceeds about 15 miles, the method further comprises the step of providing one or more bridge antennas that singly or in combination have a line-of-sight with the base unit to relay the transmission to the base unit.

In another embodiment of the present invention, the method includes the steps of storing decompressed and decoded video signal data in memory and/or displaying the video signal data on a display device. Further, the method includes the steps of establishing that a user is a restricted access user and, moreover, enabling one or more users to remotely control the orientation of the video recording devices.

### BRIEF DESCRIPTION OF THE DRAWINGS

The invention will be better understood by reference to the following more detailed description and accompanying drawings where like reference numbers refer to like parts:

FIG. 1 is an illustrative embodiment of a video signal data feed system in accordance with the present invention;

FIG. 2 is an illustrative embodiment of a mobile video unit of the video signal data feed system in accordance with the present invention;

FIG. 3 is an illustrative embodiment of a base, receiver unit of the video signal data feed system in accordance with the present invention; and

FIGS. 4A and 4B are a flow chart of an embodied method of providing video signal data using low frequency bandwidths in accordance with the present invention.

### DETAILED DESCRIPTION OF THE INVENTION AND PREFERRED EMBODIMENTS THEREOF

In its broadest aspects, the present invention provides systems, devices, and methods for providing data to a remote location using low frequency bandwidth. One preferred embodiment of the present invention provides video signal data and is described below for illustrative purposes. However, the invention is not to be construed as being so limited. More specifically, in addition to video signal data, the present invention provides systems, devices, and methods for providing video signal data, audio data, text data for significant distances using low frequency bandwidth.

In a preferred embodiment, the present invention provides a surveillance and monitoring system that includes one or more mobile video units and a transceiver. The mobile video units each have one or more video recording devices to record video signal data. The transceiver processes the video signal data it receives from the video units and transmits the processed video signal data to one or more remote base units. At the one or more remote base units, the video signal data are further processed and transmitted to a facility network such as the Internet, an intranet, and the like. The transceiver and base unit are structured and arranged to transmit and receive data using low frequency bandwidth. A controller enables remote users to access and view the video feed and, further, to control the one or more video devices.

In a further embodiment of the present invention, the surveillance and monitoring system optionally includes one or more bridge antennas. The one or more bridge antennas can be strategically positioned to provide line-of-sight transmissions from and to the transceiver, the base unit(s), and/or another bridge antenna. The employment of additional bridge antennas allows video signal data to be transmitted at low frequency bandwidth for several hundreds of miles.

In still another embodiment, the present invention provides a method of providing video signal data to remote locations using low frequency bandwidth.

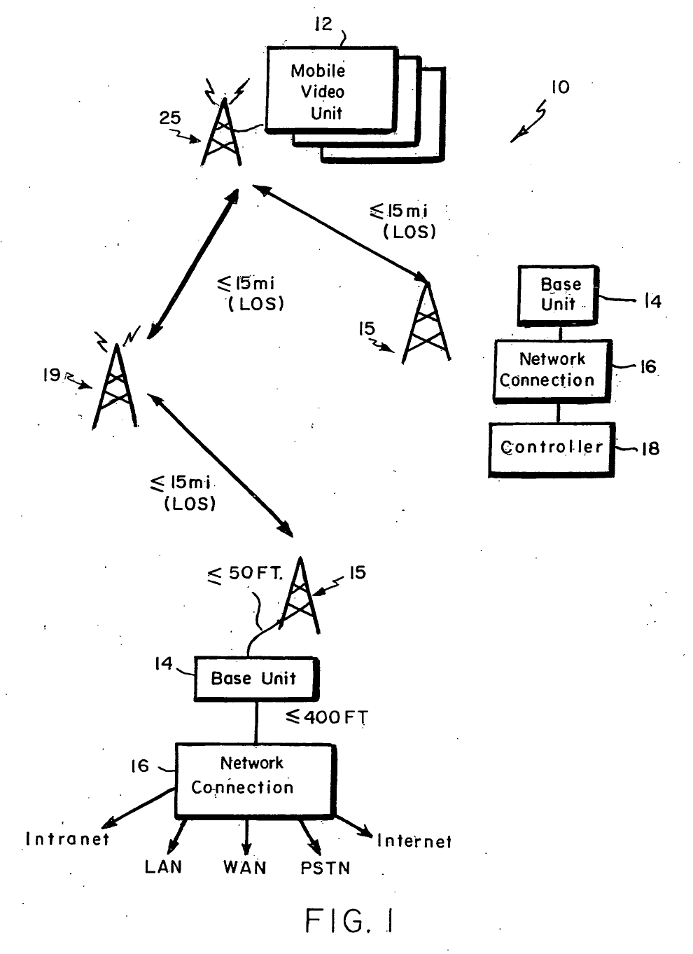

Referring to FIG. 1, a surveillance and monitoring system 10 will now be described. According to a first embodiment of the present invention, the surveillance and monitoring system 10 comprises one or more mobile video units 12, one or more base units 14, a facility network connection 16, and a system controller 18. Preferably, each base unit 14 is structured and arranged to receive compressed and encoded video signal data transmitted from multiple mobile video units 12 that are each equipped with multiple video recording devices 24. In one preferred, each base unit 14 can receive video signal data from up to 64 mobile video units 12 and each mobile video unit 12 can be equipped with up to five video recording devices 24. Thus, in this particular embodiment, a single base unit 14 can receive video signal data simultaneously from 320 unique video recording devices 24.

According to the present invention, each base unit 14 and each mobile video unit transceiver 20 are structured and arranged to operate on any number of channels and sub-frequencies in the 2.4 Giga-hertz (“GHz”) to about 5.8 GHz ISM frequency bandwidth (hereinafter “low frequency bandwidth”) using conventional low frequency protocols. Although only two base units 14 and three mobile video units 12 are shown in FIG. 1, the invention is not to be construed as being so limited as fewer or more base units and mobile video units can be included in a system 10.

Use of low frequency bandwidth in accordance with the teachings of this invention is unique. Low frequency bandwidth is covered by FCC Part 15 regulations, which allows for license-free and cost-free operation. As a result, its use does not require the purchase or lease of bandwidth. Moreover, it is little affected by meteorological disturbances, e.g., fog, rain, sleet, snow, and the like, or other communication devices operating on the same or substantially the same frequency.

Currently, wireless-fidelity networks, i.e., “Wi-Fi” or “802.11” networks, and cordless telephones are the popular—albeit nonexclusive—users of low frequency bandwidth. Wi-Fi networks use microwave radio signals that can travel through walls, floors, ceilings, and other obstacles to connect telecommunication devices equipped with wireless radios, e.g., personal data assistants (“PDAs”), desktop personal computers (“PCs”), and laptop computers, to an Internet or intranet gateway, i.e., “access point” or “hot spot”, wirelessly. In one simple adaptation, a universal serial bus (“USB”) Wi-Fi radio operating in low frequency bandwidth can be connected to an available USB port on one's desktop PC or laptop computer or to the compact flash outlet of a PDA. The access point sends and receives wireless, RF signals to communicate between the Wi-Fi radio and the Internet or intranet gateway.

Conventionally, the maximum effective range between a Wi-Fi device and the gateway is about 300 feet outdoors and about 150 feet indoors, where the range is diminished because of the damping effect of the walls, floors, ceilings, and the like. Certain applications, e.g., those used to support fire/rescue operations have an increased operating range between about 400 and about 700 feet. However, even this increased operating range does not provide transmissions for significant distances. As a result, those skilled in the art would not consider using low frequency bandwidth to provide live, continuous, real-time, high-resolution video transmissions for distances of about 15 miles or much greater.

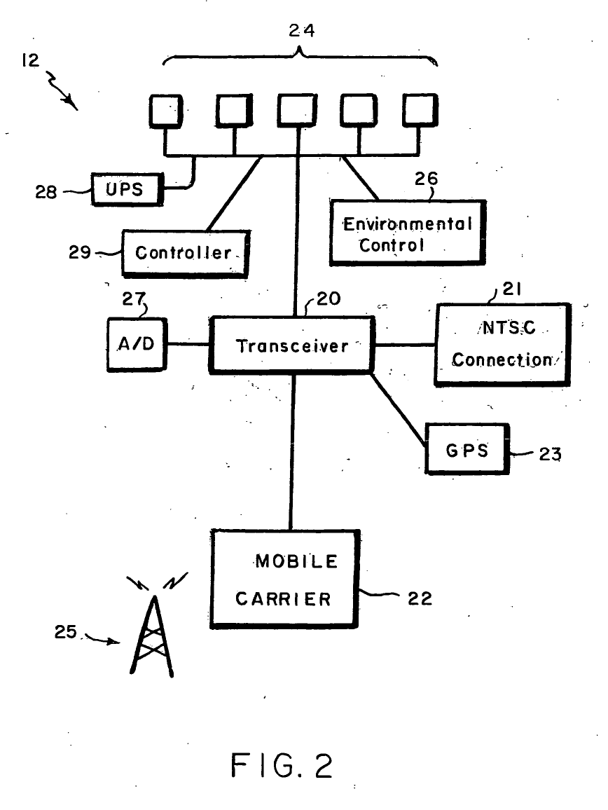

Referring to FIG. 2, an embodiment of a mobile video unit 12 will now be described. Preferably, each mobile video unit 12 comprises a mobile carrier 22, e.g., a police vehicle, a fire vehicle, an emergency response vehicle (“ERV”), snow removal equipment, a mobile command vehicle, a runway control vehicle, and the like, to transport the other components of the mobile video unit 12 to a particular location. One or more video recording devices 24 are removably attached to the mobile carrier 22 to provide continuous video signal data. An environment control system 26 protects the video recording devices 24 from extreme operating conditions, e.g., heat or cold. An uninterruptible power source 28 ensures that the video recording devices 24 operates without interruption.

A transceiver 20 receives video signal data from one or more video recording devices 24; processes the data; encodes the data; and transmits the data to one or more base units 14. The transceiver 20 also receives control and other signal data from the one or more base units. Particularly, the transceiver 20 receives control data to control the video recording devices 24. In a one application of the present invention, each transceiver 20 can control and receive video signal data from up to five video recording devices 24. However, the invention is not to be construed as being so limited. Indeed, if needed, those skilled in the art could provide means for a transceiver 20 to receive, process and transmit data from more than five video recording devices 24.

In some embodiments of the present invention, the one or more video recording devices 24 provide raw video signal data, e.g., analog or digital, via a hardwire to the transceiver 20. Those skilled in the art realize that wireless data can be provided from more sophisticated video recording devices 24 to more sophisticated transceivers 20. The video recording devices 24 can operate continuously to provide a continuous video stream, i.e., “feed”; and/or the video recording devices 24 can be activated locally or remotely to record and transmit video signal data only when occurrences or events so warrant; and/or the video recording devices 24 can be equipped with motion detection devices (not shown) that activate the video recording devices 24 upon detection of some relative movement. Preferably, the video recording devices 24 are structured and arranged to be controllable locally or remotely to zoom, pan, focus, and/or tilt the camera lens as desired.

The video recording devices 24 can include high resolution, color cameras and, more preferably, can include digital as well as analog color video cameras. Although the preferred transmitted signal from the video recording device 24 to the base unit(s) 14 via the transceiver 20 is a digital signal, video signal data from the video recording devices 24 to the transceiver 20 can include digital signals from a digital video recording device 24 and/or analog signals from an analog video recording device 24. When the video recording device 24 provides analog signal data to the transceiver 20, the analog signals are converted to digital IP format by the transceiver 20, e.g., using an analog/digital converter 27.

Preferably, the video recording devices 24 can deliver streaming video data at a rate between about 15 and about 30 frames per second. More preferably, the video recording devices 24 include camera features such as at least a 16× zoom, at least a 340-degree pan, and at least a 100-degree tilt and, moreover, these features can be controlled locally or remotely.

In another aspect of the first embodiment of the present invention, other video recording devices, e.g., closed-circuit cameras, infra-red (“IR”) cameras, night vision devices, and the like, can be connected to the transceiver 20, e.g., via an NTSC connection 21. By connecting another video recording device to the transceiver 20 via an NTSC connection 21, a live video feed of an object from the video recording device 24 and, for example, an IR feed of the same object from an IR camera can be transmitted to one or more base units 14 simultaneously. As a result, the video feed data can be compared with any “hot spots” that are picked up by the IR system.

More advantageously, the NTSC connection 21 provides an external data portal through which any data from any other source can be relayed to a remote base unit 14 and subsequently to remote users. Accordingly, the present invention can transmit audio and computer data, among others, to remote locations using low frequency bandwidths. The NTSC connection 21 also allows local users to connect to the transceiver 20 to receive video signal data directly from the transceiver 20.

Video recording devices 24 can be securely and removably attached to the mobile carrier 22 at strategic locations to provide maximum visual coverage. Video recording devices 24 can be mounted directly onto the mobile carrier 22 or, more preferably, onto a specially designed mounting assembly (not shown), which is then mounted on and removable from the mobile carrier 22. For example, a video recording device 24 and/or mounting assembly can be mounted on one or more of the front bumper, the rear bumper, a roof mount, a side mount, and/or in the interior of the mobile carrier 22. Preferably, one or more video recording devices 24 are roof-mounted to provide greater vision and panning capability and to be less susceptible to damage. More preferably, the video recording devices 24 are mounted on controllable, rotatable and articulating bases that allow authorized users to change the orientation, i.e., zoom, pan, tilt angle, and the like, of the video recording device 24, locally or remotely.

In another aspect of the present invention, the video recording devices 24 are mounted in an environment control chamber 26, i.e., hermetically sealed, to control and optimize the operating temperature of the video recording devices 24 during extreme weather conditions. Preferably, the environment control system 26 can heat and cool the video recording devices 24 as necessary to maintain an optimal working environment.

Power to each video recording device 24 should be uninterruptible. The source 28 providing power to each video recording device 24 can include the DC power source (not shown) for the mobile carrier 22; however, it is preferred that, the video recording devices 24 are powered by discrete, dedicated uninterruptible power systems 28, e.g., a DC battery, a fuel cell, a solar cell in combination with a battery, and the like. A single, uninterruptible power system 28 that is independent of the DC power source of the mobile carrier 22 can provide power to all of the video recording devices 24 on a particular mobile unit 12, or, alternatively, each video recording device 24 can be equipped with its own, smaller uninterruptible power system 28.

The transceiver 20 receives video signal data from each of the plurality of video recording devices 24. Each of the video recording devices 24 is hardwired to the transceiver 20 to provide continuous video signal data, e.g., using TCP/IP. As provided before, the transceiver 20 can also receive video signal data from devices in communication with the transceiver via an NTSC connection 21 and/or other data from the same. If the video signal data are analog signals, the transceiver 20 first converts the analog signals to a digital IP format. If the video signal data is digital data then conversion is not necessary.

The transceiver 20 can then encode the digital (or digitized) data signals. Preferably, a 128-bit encryption scheme or, alternatively, a Wi-Fi, WEP security layer can be used for encoding purposes. The encoded data can then be compressed and transmitted to the base unit(s) 14 using a low frequency bandwidth. Transmission of data can include circuit-switched circuits or packet-switched circuits; although packet-switched circuits are preferred.

Preferably, the transceiver 20 is mounted to the mobile carrier 22 and powered by the DC power source, i.e., a 12-volt battery, of the mobile carrier 22. Although a preferred embodiment of this invention includes a mobile video unit 12, the present invention does not preclude the use of stationary video recording devices 24. When the transceiver 20 and video recording devices 24 are stationary, the transceiver 20 can also be powered by the uninterruptible power system 28 that powers the video recording devices 24.

Each transceiver 20 is in communication with and provides a wireless interface with an integral omni-directional or a focused, directional antenna 25. Preferably, the omni-directional or focused, directional antenna 25 is structured and arranged to send continuous, low frequency video signal data transmissions to a main antenna 13 located at or near the base unit 14 or, alternatively, to an intermediate bridge antenna 19 that re-transmits the video signal data to the main antenna 13 at or near the base unit 14. The embodied mobile video units 12 can provide continuous, high-resolution streaming video signal data to a base unit(s) 14 up to about 15 miles away (LOS).

However, because the omni-directional antenna 25 is a low frequency, LOS antenna, natural and man-made obstructions and obstacles between the base unit antenna 15 and the mobile video unit antenna 25 can diminish the broadcast range. In such instances, or when greater transmission ranges are desired, one or more bridge antennas 19 can be structured and arranged at a discrete location between the base unit 14 and the mobile video unit 12. The bridge antenna 19 comprises a focused, directional antenna with a line-of-sight to the main antenna 13 at or near the base unit 14. Ranges of about 15 miles (LOS) are possible between each antenna pair. Thus, with multiple bridge antennas 19, the transmission range can approach several hundred miles as long as there is LOS between antennas. Accordingly, geographical areas that otherwise might not be accessible to the mobile video units 12 are made accessible using one or more intermediate, bridge antennas 19.

Each mobile video unit 12 further includes a controller 29 that is in communication with the transceiver 20 and the video recording devices 24. In a preferred embodiment, the controller 29 is a programmable microprocessor that includes random access memory (“RAM”) and read-only memory (“ROM”). The ROM can include one or more operating programs, i.e., applications, e.g., to control the video recording devices 24 and to enable communication of data signals to and from the base unit(s) 14, and the like.

In another embodiment of the present invention, the mobile video unit 12 can also include a global plotting system (“GPS”) signal generator 23. GPS signal generators 23 provide a signal to a satellite so that the location of the mobile video unit 12 can be tracked. As a result, video signal data received from the mobile video unit 12 can be tagged as to its exact or precise location. In yet another embodiment of the present invention, the mobile video unit 12 can include a plurality of sensors that can provide general data on local conditions, e.g., temperature, humidity, visibility, and the like, and/or a plurality of sensors that detect movement, further enabling the video recording devices 24 to home in on the moving object and track its movement. In a further embodiment of the present invention, the transceiver 20 can be enclosed in a weather-resistant enclosure (not shown) to protect it from the elements and damage.

Having described the mobile video unit 12 and a bridge antenna 19 for expanding the operating range of the mobile video unit 12, a preferred embodiment of a base, or receiver, unit 14 will now described. The base unit 14 receives the wireless streaming video feed and other data from the mobile video units 12 (or a bridge antenna 19); processes the data; and re-transmits the data through a facility network connection 16. The facilities network connection 16 provides an access or gateway to one or more of an intranet, the Internet, a local area network (“LAN”), a wide area network (“WAN”), a public switched telephone network (“PSTN”) or other conventional communication networks, e.g., cellular and wireless telephones, digital pagers, PDA's, and other wireless devices, and the like.

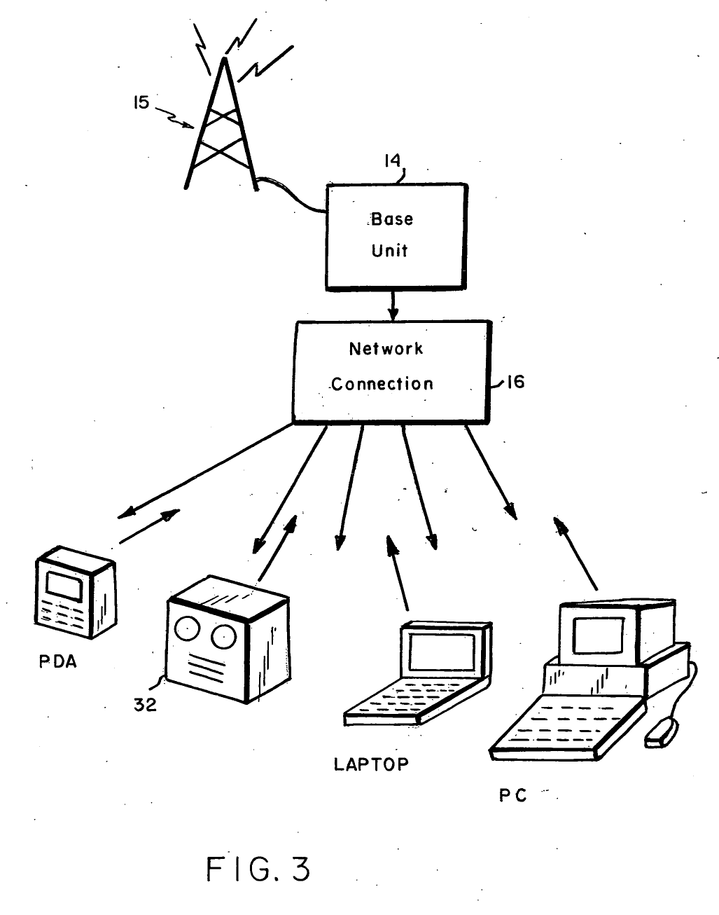

Referring to FIG. 3, the base unit 14 can be hardwired to the main antenna 13 and further hardwired to the facility network connection 16, e.g., using a Cat5 or fiber optic Ethernet connection. Preferably, the base unit 14 is located within about 50 feet of the main antenna 13 and, more preferably, the base unit 14 is located within about 400 feet of the facility network connection 18. Adherence to these distances minimizes loss of quality in the transmission.

The base unit 14 receives encoded, compressed video signal data and other data transmissions from the transceiver 20 and decompresses and decodes the signal. As previously stated, the transmission can be protected by a 128-bit encryption scheme or a “Wi-Fi”, WEP security layer to ensure that only authorized personnel can access the transmitted data. Once the video signal data are decoded, the data are transmitted to the facility network connection 16 through which the video signal data are further transmitted to users and/or memory storage 32 over the Internet or via an intranet, LAN, WAN, PSTN, and the like. Transmission over the Internet and some intranets enables authorized users to view the displayed video signal data from distances that can exceed hundreds or thousands of miles. Moreover, restricted access users can, further, control the transmission of video signal data from distances that can exceed hundreds or thousands of miles.

In a preferred embodiment, the base unit 14 requires 110-120 V AC, 60 Hz power from a commercial power source, e.g., a utility power line, or from its own power source (not shown). Moreover, the base unit 14 uses a removable and updatable interface card to provide the connection between the antenna 15 and the facility network connection 16. Optionally, the base unit 14 can be mounted in a weatherproof enclosure (not shown).

In another embodiment of the present invention, preferably, on the client side of the facility network connection 16, a controller 18 is structured and arranged to provide authorized user access to video signal and other data and, moreover, to provide remote control of the video recording devices 24 to restricted access users. In a preferred embodiment, the controller 18 is a programmable microprocessor that includes random access memory (“RAM”) and read-only memory (“ROM”). The ROM can include one or more operating programs, i.e., applications. For example, the controller 18 can include security and interface software.

Interface software enables authorized users to access, view, and record the live video stream and other data from any access point in the facility network 16. Moreover, interface software enables restricted access users to control the video recording devices 24.

Security software prevents unauthorized users from accessing the system 10 and having access to the video signal data and/or other data. Preferably, security software includes a LOGIN application requiring any user to input a valid password or passcode to access the system 10. More preferably, the security software also includes an additional security layer to differentiate between view-only users, who can only observe the transmitted data, and restricted access users, who not only can observe the transmitted data, but who can also control the remote video recording devices 24. Unique passwords or passcodes and a look-up table of unrestricted use users can be used to differentiate between the two user types.

Preferably, user access is accomplished through a Web browser over the Internet using a PC. Moreover, video feed data for viewing are provided at speeds of between about 15 and 30 feet per second. When multiple video recording devices 24 are transmitting data, one or more video images can be shown on any user screen. Accordingly, users can view data from a single video recording device 24, multi-camera, split screen data from a plurality of video recording devices 24, thumbnail data from all of the video recording devices 24, and any combination thereof. Multiple authorized users can view the same or different video feeds concurrently. All video signal and other data are capable of being saved to memory; however, because of the continuous nature and potential number of the video feeds, this may be impractical. Therefore, preferably, only video and other data provided to the senior user, who also can be identified by a unique password or passcode, will be recorded to memory to create a historical record of the event.

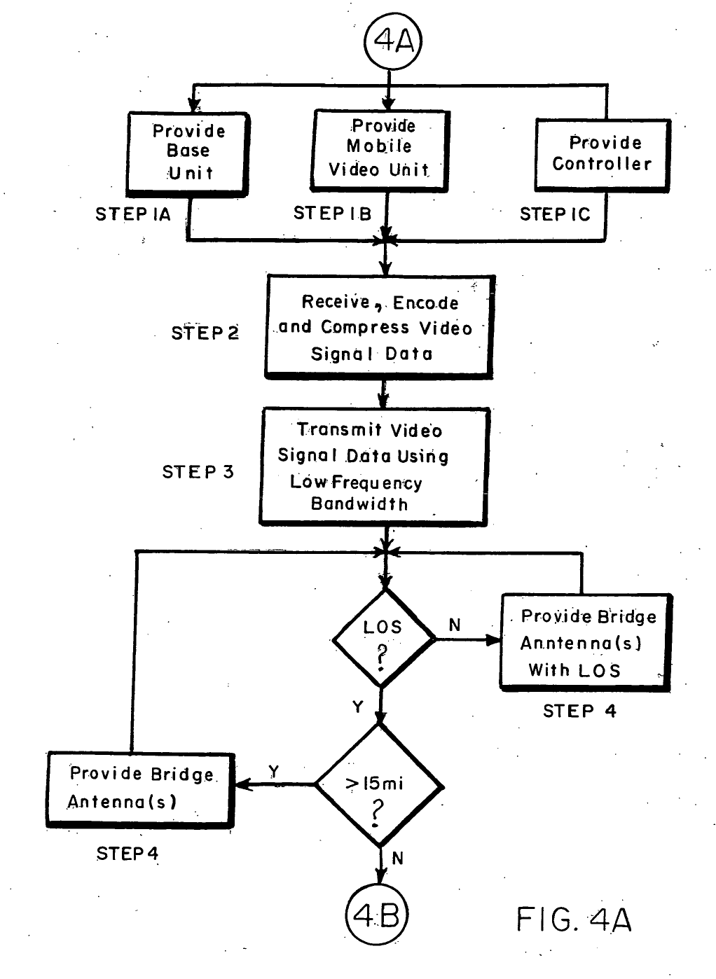

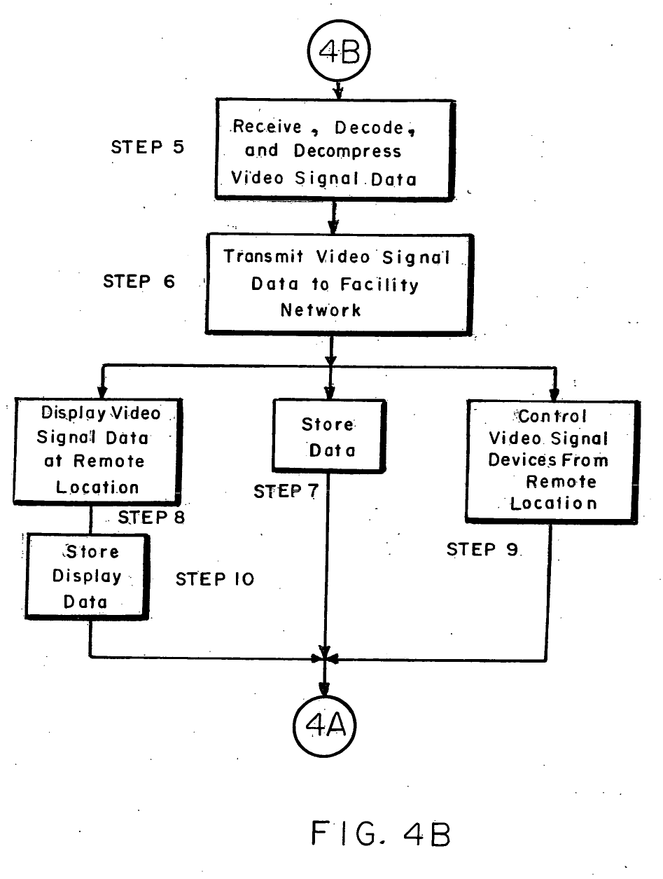

In another embodiment, a method of providing continuous, live, real-time video signal data to a remote location using low frequency bandwidth will be described. Referring to FIGS. 4A and 4B, the method first includes the steps of providing a surveillance and monitoring network having one or more base units STEP 1A similar to those described in the first embodiment; providing one or more mobile video units STEP 1B similar to those described in the first embodiment; and providing a controller STEP 1C similar to the one described in the first embodiment.

The mobile video unit includes one or more video recording devices that provide video signal data to a transceiver. The transceiver receives, encodes, and compresses the video signal data from the video recording devices STEP 2 and transmits the encoded, compressed video signal data in digital IP format to the base unit STEP 3.

If there is line-of-sight between the transceiver and the base unit and the transceiver and base unit are within about 15 miles of each other, then the transmitted video signal data are directionally transmitted right to the base unit. However, if there is no line-of-sight between transceiver and the base unit and/or the distance between the transceiver and the base unit exceeds about 15 miles, then one or more bridge antennas should be provided STEP 4 to relay the transmission to the base unit.

After the video signal data are received at the base unit, the base unit decodes and decompresses the data STEP 5 and re-transmits the decoded, decompressed video signal data to a facility network STEP 6, which can include an intranet, the Internet, a LAN, a WAN, a PSTN, and/or wireless devices, such as PDAs, pagers, and the like.

In another embodiment of the present invention, all or some portion of the video signal data can be stored in memory STEP 7 or, alternatively, only that video signal data that has been viewed by a restricted use user can be stored in memory STEP 10.

At any time during the STEPS 1-6, a user can access the system through the facility network. Access to the system provides remote displays of video signal data to any authorized user STEP 8 and/or provides remote control of the video recording devices to any restricted access users STEP 9. More specifically, the controller uses interface and security logarithms, i.e., software, that prompts users to identify themselves, e.g., by entering a password or passcode. Passwords and passcodes that are entered by users are then compared to passwords and passcodes that are stored, e.g., in a look-up table, in memory.

Although the flow chart shows the remote control step STEP 9 occurring after STEPS 1-7, the invention is not to be construed as requiring that sequence. Indeed, preferably, an unrestricted use user can control video recording devices at any time during the video signal data transmission sequence and be within the scope and spirit of this disclosure.

For example, although the invention has been described using low frequency transmissions between about 2.4 and about 5.8 GHz ISM, the invention is not to be construed as being so limited. Indeed, in another embodiment, the present invention includes frequency transmissions in the range of up to about 1 Terra-hertz. This may require some licensing and, furthermore, the transmission range between antennas is reduced. However, transmission of high-resolution, live, real-time video signal data in the 1 Terra-hertz range is possible.

Although the invention has been described using a “mobile” video unit, that is not to say that the system also cannot be adapted for stationary application. For example, for some remote locations, e.g., along the Alaska pipeline or the Texas border, one or more video recording devices 24 and transceivers 20 can be securely and fixedly or removably mounted to a wall, frame, column, post, truss, derrick, antenna, and the like. When such a system is in an area that does not have access to an AC power source and/or where employment of a generator would be impractical, solar and/or wind power can be used to provide the uninterruptible power source 28. Indeed, in a preferred embodiment, eight (8) solar panels in combination with five (5) marine batteries can provide continuous, 24-hour coverage as long as five, heavily overcast days do not occur successively.

In another embodiment, a mobile video unit can also be mounted on fixed and/or rotary wing aircraft. Fixed wing and rotary aircraft, typically, enable easier line-of-sight capabilities, which can reduce the need or number of bridge antennas.

In yet another embodiment, the video recording devices can be small “wearable cameras” such as those used by firemen, which are well known to those skilled in the art.

In a further embodiment, although a controller on the client side is preferred, that is not to say that the controller could not be on the server, i.e., the base unit, side of the facility network connection.

In still a further embodiment, although the invention has been described having hardwired communication between the transceiver and the video recording devices and/or any devices connected to the NTSC connection. The invention, however, is not limited to hardwired communication. Indeed, the present invention further includes wireless communication between the transceiver and the video recording devices and/or any devices connected to the NTSC connection.

Although preferred embodiments of the invention have been described using specific terms, such descriptions are for illustrative purposes only, and it is to be understood that changes and variations may be made without departing from the spirit or scope of the following claims.

1. A system for transmitting data to one or more remote locations using low frequency bandwidth transmissions, the system comprising:
one or more transmitting units, each of the one or more transmitting units comprising:
a transceiver for processing data provided from one or more data generating devices, wherein the transceiver transmits said data using a low frequency bandwidth; and
one or more remote receiving devices for processing transmitted data received from the one or more transmitting units, wherein said one or more remote receiving devices re-transmits said data to a facility network.

2. The system as recited in claim 1, wherein the low frequency bandwidth is between about 2.4 Giga-hertz and about 1 Terra-hertz ISM.

3. The system as recited in claim 2, wherein the low frequency bandwidth is between about 2.4 Giga-hertz and about 5.8 Giga-hertz ISM.

4. The system as recited in claim 1, wherein the one or more transmitting units is a mobile transmitting unit that further comprises a mobile video carrier to transport the transceiver and one or more data generating devices to a particular location.

5. The system as recited in claim 1, wherein the one or more transmitting units further comprises one or more data generating devices that provide at least one of audio data, video data or text data to the transceiver.

6. The system as recited in claim 1, wherein the one or more transmitting units of the system further includes an antenna that is in communication with the transceiver.

7. The system as recited in claim 6, wherein the antenna is an omnidirectional antenna or a focused, directional antenna and said antenna is capable of transmitting data and receiving signals at a range of about 15 miles (line-of-sight).

8. The system as recited in claim 7, wherein the system further comprises one of more bridge antennas, when a distance between the antenna and the one or more remote receiving devices exceeds about 15 miles or when there is not 15 miles line-of-sight,
wherein each of the one or more bridge antennas has a line-of-sight communication with said one or more remote receiving devices or another of said one or more bridge antennas.

9. The system as recited in claim 1, wherein the one or more transmitting units of the system further includes a controller that is in communication with the transceiver and one or more data generating devices to enable communication of data to said one or more remote receiving devices and to control one or more of said data generating devices.

10. The system as recited in claim 1, wherein the one or more remote receiving devices comprises a main antenna, a base unit, and a facility network connection.

11. The system as recited in claim 10, wherein the facility network connection provides an access or a gateway to one or more of the Internet, an intranet, a wide area network, a local area network, a public switched telephone network, a cellular communication network, a digital pager, or a wireless communication network.

12. The system as recited in claim 1, wherein processing by the one or more remote receiving devices includes decoding and decompressing data received from the transceiver.

13. The system as recited in claim 1, wherein the one or more remote receiving devices re-transmit data for display on a display device that is in communication with the facility network.

14. The system as recited in claim 1, wherein the one or more remote receiving devices re-transmit data for storage in memory.

15. A system for transmitting data to one or more remote locations using low frequency bandwidth transmissions, the system comprising:
one or more video units, each of the one or more video units comprising:
a transceiver for processing video signal data, wherein the transceiver transmits said video signal data using a low frequency bandwidth; and
one or more remote receiving devices for processing the transmitted video signal data received from the one or more video units, wherein said one or more remote receiving devices re-transmits the processed video signal data to a facility network.

16. The system as recited in claim 15, wherein the low frequency bandwidth is between about 2.4 Giga-hertz and about 1 Terra-hertz ISM.

17. The system as recited in claim 16, wherein the low frequency bandwidth is between about 2.4 Giga-hertz and about 5.8 Giga-hertz ISM.

18. The system as recited in claim 15, wherein the one or more video units is a mobile video unit that further comprises a mobile video carrier to transport the transceiver and one or more video recording devices to a particular location.

19. The system as recited in claim 15, wherein the one or more video units further comprise one or more video recording devices that provide continuous, live, real-time video signal data.

20. The system as recited in claim 19, wherein the one or more video recording devices comprises a video camera having at least a 16× zoom feature, at least a 340-degree pan feature, and at least a 100-degree tilt feature.

21. The system as recited in claim 20, wherein the zoom-, pan- and tilt features are controllable locally or remotely.

22. The system as recited in claim 19, wherein the one or more video recording devices includes one or more closed-circuit cameras, night vision devices or infrared cameras.

23. The system as recited in claim 22, wherein each of the one or more closed-circuit cameras, night vision devices or infrared cameras provides video signal data to the transceiver through an NTSC connection.

24. The system as recited in claim 19, wherein each of the one or more video recording devices is enclosed in an environment control chamber to regulate and optimize operating conditions of said one or more video recording devices.

25. The system as recited in claim 19, wherein each of the one or more video recording devices is powered by a power source.

26. The system as recited in claim 20, wherein the power source is selected from a group consisting of a DC power source to a mobile video carrier, a 12-volt DC battery, a fuel cell, a solar cell, a wind generator, and any combination thereof.

27. The system as recited in claim 19, wherein the one or more video recording device is structured and arranged with a motion sensor that actives said one or more video recording device upon detection of any movement.

28. The system as recited in claim 19, wherein the one or more video recording device is structured and arranged to provide video signal data at a rate of between about 15 frames per second and about 30 frames per second.

29. The system as recited in claim 15, wherein processing video signal data by the transceiver includes encoding and compressing video signal data received by said transceiver from one or more video recording devices.

30. The system as recited in claim 29, wherein encoding includes a 128-bit encryption scheme or a wireless-fidelity, WEP security layer.

31. The system as recited in claim 15, wherein the transceiver can receive and process video signal data from a plurality of video recording devices.

32. The system as recited in claim 31, wherein the transceiver can receive and process video signal data from up to five video recording devices.

33. The system as recited in claim 15, wherein the transceiver is in communication with an analog/digital converter to convert analog video signal data to digital IP format video signal data.

34. The system as recited in claim 15, wherein the one or more video units further includes an antenna, which is in communication with the transceiver.

35. The system as recited in claim 34, wherein the antenna is an omnidirectional antenna or a focused, directional antenna and said antenna is capable of transmitting video signal data and receiving signals at a range of about 15 miles (line-of-sight).

36. The system as recited in claim 35, wherein, the system further comprises one of more bridge antennas, when a distance between the antenna and the one or more remote receiving devices exceeds about 15 miles or when there is not 15 miles line-of-sight,
wherein each of the one or more bridge antennas is structured and arranged to provide line-of-sight communication with said one or more remote receiving devices or another of said one or more bridge antennas.

37. The system as recited in claim 35, wherein the antenna is capable of transmitting video signal data to the one or more remote receiving devices through the one or more bridge antennas for a distance of about (n+1) times 15 miles (line-of-sight), where n is the number of bridge antennas.

38. The system as recited in claim 15, wherein the one or more video units further includes a controller that is in communication with the transceiver and one or more data video recording to control the positioning and orientation of said one or more video recording devices and to enable communication of video signal data to the remote receiving devices.

39. The system as recited in claim 15, wherein the one or more video units comprises a global plotting system signal generator to provide precise location data about said one or more video units.

40. The system as recited in claim 15, wherein the one or more remote receiving devices comprises a main antenna, a base unit, and a facility network connection.

41. The system as recited in claim 40, wherein the base unit is located within about 50 feet of the main antenna and no more than about 400 feet from the facility network connection.

42. The system as recited in claim 15, wherein each of said one or more remote receiving devices can receive video signal data from a plurality of transceivers.

43. The system as recited in claim 42, wherein each of said one or more remote receiving devices can receive video signal data from about 64 transceivers.

44. The system as recited in claim 40, wherein the facility network connection provides an access or a gateway to one or more of the Internet, an intranet, a wide area network, a local area network, a public switched telephone network, a cellular communication network, a digital pager, or a wireless communication network.

45. The system as recited in claim 15, wherein processing by the one or more remote receiving devices includes decoding and decompressing video signal data received from the transceiver.

46. The system as recited in claim 45, wherein decoding includes a 128-bit encryption scheme or a wireless-fidelity, WEP security layer.

47. The system as recited in claim 15, wherein the system further comprises a system controller that is structured and arranged to enable authorized users to access the system from a remote location.

48. The system as recited in claim 15, wherein the system further comprises a system controller that is structured and arranged to enable restricted access users to access the system and to control the positioning and orientation of the one or more video recording devices from a remote location.

49. The system as recited in claim 15, wherein the one or more remote receiving devices re-transmit video signal data for display on a display device that is in communication with the facility network.

50. The system as recited in claim 15, wherein the one or more remote receiving devices re-transmit video signal data for storage in memory.

51. A method for transmitting data to one or more remote locations using low frequency transmissions, the method comprising the steps of:
providing a network having one or more transmitting units, and one or more receiving units, wherein each of the one or more transmitting units receives data from one or more data generating devices;
processing the data received from the one or more data generating devices;
transmitting the processed data to the one or more receiving units;
processing the transmitted data;
transmitting the processed data to a facility network; and
displaying the data on a display device in communication with the facility network to one or more authorized users.

52. The method as recited in claim 51, wherein data are transmitted at a low frequency bandwidth between about 2.4 Giga-hertz and about 1 Terra-hertz ISM.

53. The method as recited in claim 52, wherein the data are transmitted at a low frequency bandwidth between about 2.4 Giga-hertz and about 5.8 Giga-hertz ISM.

54. The method as recited in claim 51, wherein the step of processing the data includes the sub-steps of encoding and compressing the data.

55. The method as recited in claim 51, wherein the step of transmitting the processed data includes providing a line-of-sight transmission between at least one of the one or more transmitting units and at least one of the one or more receiving units.

56. The method as recited in claim 54, wherein a distance between said at least one of the one or more transmitting units and said at least one of the one or more receiving units does not exceed about 15 miles.

57. The method as recited in claim 56, wherein the method further comprises the step of providing one or more bridge antennas that singly or in combination provide a line-of-sight with said one or more bridge antennas to relay the transmission to said one or more receiving unit when there is no line-of-sight between each of the one or more transmitting units and each of the one or more receiving units or when the distance between each of the one or more transmitting units and each of the one or more receiving units exceeds about 15 miles.

58. The method as recited in claim 51, wherein the step of processing the transmitted data includes the sub-steps of decompressing and decoding the data.

59. The method as recited in claim 58, wherein the step of transmitting the processed data to a facility network includes the sub-step of providing an access or a gateway to one or more of the Internet, an intranet, a wide area network, a local area network, a public switched telephone network, a cellular communication network, a digital pager, or a wireless communication network.

60. The method as recited in claim 51, wherein the step of displaying the data to one or more authorized users further includes the step of authenticating that a user is an authorized user.

61. A method for transmitting video signal data to one or more remote locations using low frequency transmissions, the method comprising the steps of:
providing a network having one or more transmitting units, and one or more receiving units, wherein each of the one or more transmitting units receives data from one or more video recording devices;
processing the data received from the one or more video recording devices;
transmitting the processed data to the one or more receiving units;
processing the transmitted data;
transmitting the processed data to a facility network; and
displaying the video signal data on a display device in communication with the facility network to one or more authorized users.

62. The method as recited in claim 61, wherein the video signal data are transmitted at a low frequency bandwidth between about 2.4 Giga-hertz and about 1 Terra-hertz ISM.

63. The method as recited in claim 62, wherein the video signal data are transmitted at a low frequency bandwidth between about 2.4 Giga-hertz and about 5.8 Giga-hertz ISM.

64. The method as recited in claim 61, wherein the step of processing the video signal date includes the sub-steps of encoding and compressing the video signal data.

65. The method as recited in claim 61, wherein the step of transmitting the processed video signal data includes providing a line-of-sight transmission between at least one of the one or more transmitting units and at least one of the one or more receiving units.

66. The method as recited in claim 65, wherein a distance between said at least one of the one or more transmitting units and said at least one of the one or more receiving units does not exceed about 15 miles.

67. The method as recited in claim 66, wherein the method further comprises the step of providing one or more bridge antennas that singly or in combination provide a line-of-sight with said one or more bridge antennas to relay the transmission to said one or more receiving unit when there is no line-of-sight between each of the one or more transmitting units and each of the one or more receiving units or when the distance between each of the one or more transmitting units and each of the one or more receiving units exceeds about 15 miles.

68. The method as recited in claim 61, wherein the step of processing the transmitted video signal data includes the sub-steps of decompressing and decoding the video signal data.

69. The method as recited in claim 61, wherein the step of transmitting the processed video signal data to a facility network includes the sub-step of providing an access or a gateway to one or more of the Internet, an intranet, a wide area network, a local area network, a public switched telephone network, a cellular communication network, a digital pager, or a wireless communication network.

70. The method as recited in claim 61, wherein the method further comprises the step of providing remote control of one or more video recording devices to a restricted access user.

71. The method as recited in claim 70, wherein the step of providing remote control of one or more video recording devices to a restricted access user further includes the step of authenticating that a user is a restricted access user.

72. The method as recited in claim 71, wherein the step of authenticating that a user is a restricted access includes using an interface and security algorithm to establish that the user is a restricted access user.

73. The method as recited in claim 71, wherein the step of displaying the video signal data to one or more authorized users further includes the step of authenticating that a user is an authorized user.

74. The method as recited in claim 73, wherein the step of authenticating that a user is an authorized user includes using an interface and security algorithm to establish that the user is an authorized user.
